(19) United States
(12) Patent Application Publication
(10) Pub. No.: US 2025/0062082 A1
(43) Pub. Date: Feb. 20, 2025

(54) ILLUMINATED TOUCHPAD

(71) Applicant: DARFON ELECTRONICS CORP., Taoyuan City (TW)

(72) Inventors: Heng-Yi Huang, Taoyuan City (TW); Chao-Yu Chen, Taoyuan City (TW); Hsin-Cheng Ho, Taoyuan City (TW)

(73) Assignee: DARFON ELECTRONICS CORP., Taoyuan City (TW)

(21) Appl. No.: 18/804,146

(22) Filed: Aug. 14, 2024

Related U.S. Application Data
(60) Provisional application No. 63/533,116, filed on Aug. 16, 2023.

(30) Foreign Application Priority Data
Aug. 14, 2024 (TW) 113130507

(51) Int. Cl. H01H 9/18; G06F 3/044; H01H 3/02

(52) U.S. Cl. CPC H01H 9/182; G06F 3/044; H01H 2003/0293

(57) ABSTRACT

An illuminated touchpad includes a panel, a light guide layer and a circuit board. The panel includes a first light transmitting region and a second light transmitting region. The light guide layer includes a first light guide region and a second light guide region. The circuit board includes a controller, a touch module, a first light source and a second light source. The controller controls the first light source to emit light, such that the first light guide region guides the light emitted by the first light source to the first light transmitting region. When the touch module senses that the first light transmitting region is touched, the controller controls the second light source to emit light, such that the second light guide region guides the light emitted by the second light source to the second light transmitting region.

### CROSS REFERENCE TO RELATED APPLICATION

This application claims the benefit of U.S. Provisional Application No. 63/533,116, filed on Aug. 16, 2023. The content of the application is incorporated herein by reference.

### BACKGROUND OF THE INVENTION

### 1. Field of the Invention

The invention relates to a touchpad and, more particularly, to an illuminated touchpad.

### 2. Description of the Prior Art

With the development of touch technology, touchpads can be integrated into various electronic devices, such as keyboards, mobile devices, etc. In general, a surface of the touchpad only has printed icons. When the touchpad is used in an environment with insufficient light, a user cannot easily find the desired touch position, thereby causing inconvenience in use. Furthermore, at present, the touchpad with an integrated backlight module only provide light for touch icons. When the user touches the touch icon with a finger, the touch icon will be blocked by the finger, such that the user cannot confirm whether the touch action has been performed.

### SUMMARY OF THE INVENTION

The invention provides an illuminated touchpad to solve the aforesaid problems.

According to an embodiment of the invention, an illuminated touchpad comprises a panel, a light guide layer and a circuit board. The panel comprises a first light transmitting region and a second light transmitting region. The light guide layer is located below the panel. The light guide layer comprises a first light guide region and a second light guide region. The first light guide region overlaps with the first light transmitting region. The second light guide region overlaps with the second light transmitting region. The circuit board is located below the light guide layer. The circuit board comprises a controller, a touch module, a first light source and a second light source. The touch module overlaps with the first light transmitting region. The first light source is located at a side of the first light guide region. The second light source is located at a side of the second light guide region. The controller controls the first light source to emit light, such that the first light guide region guides the light emitted by the first light source to the first light transmitting region. When the touch module senses that the first light transmitting region is touched, the controller controls the second light source to emit light, such that the second light guide region guides the light emitted by the second light source to the second light transmitting region.

As mentioned in the above, the invention disposes the first light guide region and the second light guide region in the same light guide layer. The light emitted by the first light source is guided to the first light transmitting region of the panel through the first light guide region to emit light, so as to form an illuminated pattern (e.g. touch icon) corresponding to the first light transmitting region. Furthermore, when the touch module senses that the first light transmitting region is touched, the controller controls the second light source to emit light. At this time, the light emitted by the second light source is guided to the second light transmitting region of the panel through the second light guide region to emit light, so as to form an illuminated effect corresponding to the second light transmitting region as a prompt for a touch action. A user may confirm whether the touch action has been performed through the prompt of the touch action. Since the first light guide region and the second light guide region are disposed in the same light guide layer (i.e. the first light guide region and the second light guide region are located on an identical plane), the first light guide region and the second light guide region will not increase the overall thickness of the illuminated touchpad, such that it is beneficial to a thin design of the illuminated touchpad. Furthermore, the same light guide layer including multiple light guide regions is also easier to be assembled. Since the first light transmitting region and the second light transmitting region as the illuminated pattern are formed on the panel, the resolution will be better than the pattern formed on a conventional light guide plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view illustrating a touch operation of an illuminated touchpad according to an embodiment of the invention.

FIG. 2 is a partial exploded view illustrating the illuminated touchpad shown in FIG. 1.

FIG. 3 is a partial sectional view illustrating the illuminated touchpad shown in FIG. 1.

FIG. 4 is a schematic view illustrating three different types of second light transmitting region.

FIG. 5 is a schematic view illustrating a touch operation of an illuminated touchpad according to another embodiment of the invention.

FIG. 6 is a partial exploded view illustrating the illuminated touchpad shown in FIG. 5.

### DETAILED DESCRIPTION

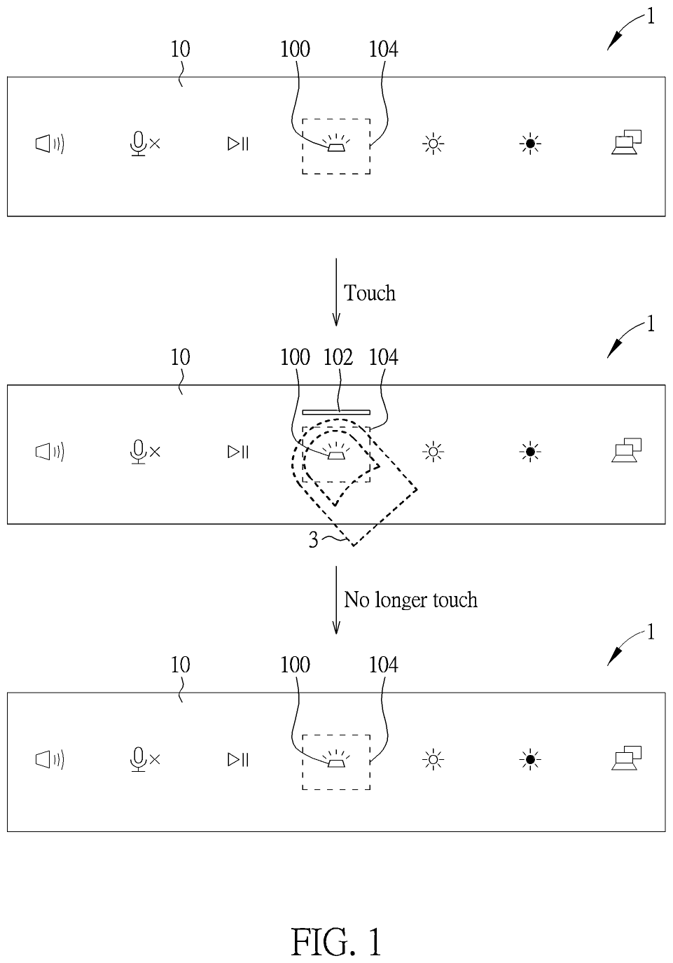

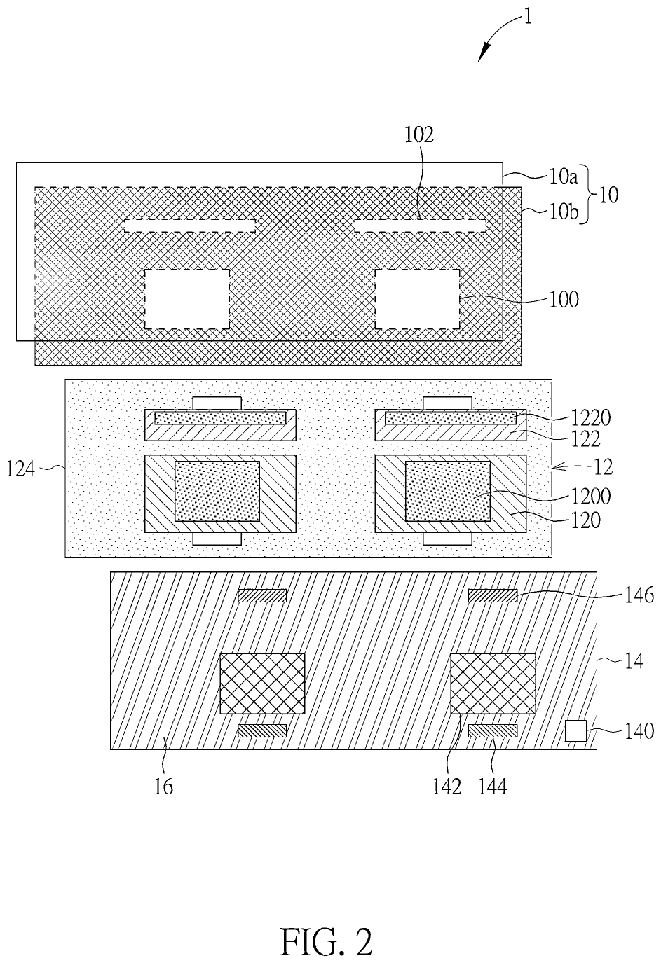

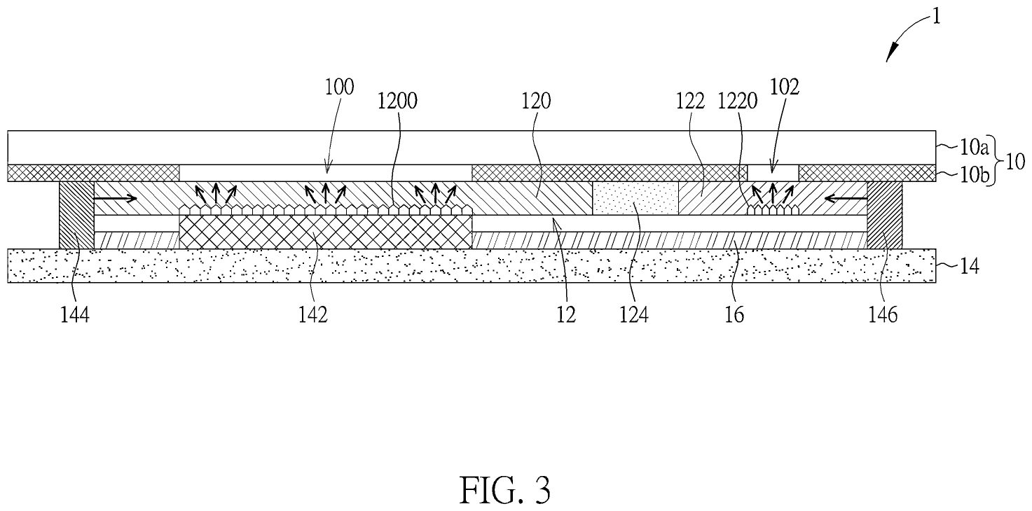

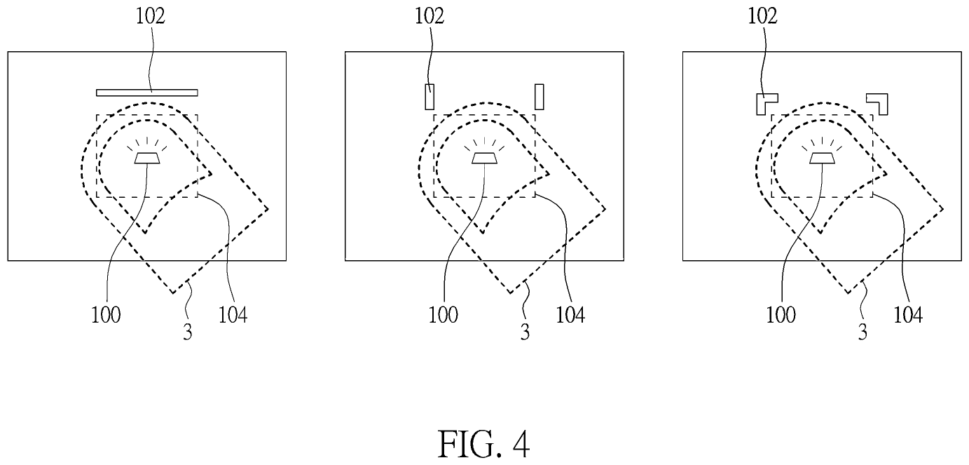

Referring to FIGS. 1 to 4, FIG. 1 is a schematic view illustrating a touch operation of an illuminated touchpad 1 according to an embodiment of the invention, FIG. 2 is a partial exploded view illustrating the illuminated touchpad 1 shown in FIG. 1, FIG. 3 is a partial sectional view illustrating the illuminated touchpad 1 shown in FIG. 1, and FIG. 4 is a schematic view illustrating three different types of second light transmitting region 102.

As shown in FIGS. 1 to 3, the illuminated touchpad 1 comprises a panel 10, a light guide layer 12 and a circuit board 14. The illuminated touchpad 1 may be applied to a touch function row or other devices with touch function. The panel 10 comprises a first light transmitting region 100 and a second light transmitting region 102. In this embodiment, the panel 10 may comprise a light transmitting layer 10a and a light shielding layer 10b, wherein the light shielding layer 10b is disposed at a side of the light transmitting layer 10a. In this embodiment, the light shielding layer 10b may be disposed at a side of the light transmitting layer 10a facing the circuit board 14. In another embodiment, the light shielding layer 10b may be disposed at another side of the light transmitting layer 10a away from the circuit board 14. In other words, the light shielding layer 10b may be disposed on one of two opposite sides of the light transmitting layer 10a according to practical applications. The light transmitting layer 10a may be glass, polycarbonate (PC) or other light transmitting plates. The light shielding layer 10b may be ink or other light shielding materials formed on the light transmitting layer 10a through printing or other manners. The light shielding layer 10b is formed with the first light transmitting region 100 and the second light transmitting region 102, wherein the first light transmitting region 100 and the second light transmitting region 102 are arranged at intervals.

The light guide layer 12 is located below the panel 10. The light guide layer 12 comprises a first light guide region 120 and a second light guide region 122, wherein the first light guide region 120 overlaps with the first light transmitting region 100, and the second light guide region 122 overlaps with the second light transmitting region 102. In this embodiment, the first light guide region 120 and the second light guide region 122 are located on an identical plane. For example, the first light guide region 120 and the second light guide region 122 may be two light guide plates spaced side by side. The two light guide plates may be connected or not according to practical applications. The light guide layer 12 may further comprise a light shielding structure 124 located between the first light guide region 120 and the second light guide region 122. The light shielding structure 124 may be a light absorbing component (e.g. black sponge, black mask, etc.), so as to prevent the light within the first light guide region 120 and the second light guide region 122 from interfering with each other. In this embodiment, the first light guide region 120 may have a first micro-structure 1200 and the second light guide region 122 may have a second micro-structure 1220, wherein the first micro-structure 1200 overlaps with the first light transmitting region 100 and the second micro-structure 1220 overlaps with the second light transmitting region 102. The first micro-structure 1200 is configured to reflect light toward the first light transmitting region 100, and the second micro-structure 1220 is configured to reflect light toward the second light transmitting region 102.

The circuit board 14 is located below the light guide layer 12. The circuit board 14 may be a printed circuit board (PCB) or other circuit boards capable of providing electrical connection, wherein the circuit board 14 may comprise a substrate and circuits on the substrate. Furthermore, the circuit board 14 comprises a controller 140, a touch module 142, a first light source 144 and a second light source 146. The touch module 142 overlaps with the first light transmitting region 100 to sense whether the first light transmitting region 100 is touched. Still further, the light shielding structure 124, the second micro-structure 1220 and the second light transmitting region 102 do not overlap with the touch module 142. The first light source 144 is located at a side of the first light guide region 120, and the second light source 146 is located at a side of the second light guide region 122. The controller 140 controls the operations of the touch module 142, the first light source 144 and the second light source 146 through the circuits of the circuit board 14. The touch module 142 is electrically connected to the circuits of the circuit board 14, generates sensing signals according to user operation, and outputs the sensing signals to a system end (e.g. computer) through the circuits. In practical applications, the touch module 142 may comprise an integrated circuit (IC) die and a package covering the IC die. The touch module 142 may comprise one or any combination of a fingerprint recognition module and any type of touch module. The first light source 144 and the second light source 146 may be light emitting diodes (LEDs) or other components capable of emitting light.

In this embodiment, a reflective sheet 16 may be disposed on the circuit board 14. The reflective sheet 16 may be configured to recover light or assist in light emission. Specifically, the reflective sheet 16 may guide the light escaping from the first light guide region 120 and the second light guide region 122 into the first light guide region 120 and the second light guide region 122 for recovery, which is beneficial to improve the light emission effect.

When the illuminated touchpad 1 is powered on, the controller 140 controls the first light source 144 to emit light, such that the first light guide region 120 guides the light emitted by the first light source 144 to the first light transmitting region 100 to emit light, so as to form an illuminated pattern (e.g. touch icon) corresponding to the first light transmitting region 100. Accordingly, a user can accurately find the desired touch position according to the illuminated pattern. In this embodiment, when the first light transmitting region 100 is not touched, the second light source 146 does not emit light. In other words, when the user does not touch the first light transmitting region 100, only the first light transmitting region 100 will emit light, and the second light transmitting region 102 will not emit light.

When the user wants to perform a touch function corresponding to the first light transmitting region 100, the user may use a finger 3 to touch the first light transmitting region 100, as shown in FIG. 1. When the touch module 142 senses that the first light transmitting region 100 is touched, the controller 140 controls the second light source 146 to emit light according to the sensing signals output by the touch module 142, such that the second light guide region 122 guides the light emitted by the second light source 146 to the second light transmitting region 102 to emit light, so as to form an illuminated effect corresponding to the second light transmitting region 102 as a prompt for a touch action. The user may confirm whether the touch action has been performed through the prompt of the touch action. In this embodiment, the panel 10 may define a touch region 104 corresponding to the first light transmitting region 100, and the second light transmitting region 102 is located beyond the touch region 104. When the user uses the finger 3 to perform a touch operation on the touch region 104, the illuminated effect corresponding to the second light transmitting region 102 will not be blocked by the finger 3. Accordingly, the user may be prompted whether the touch action has been performed. As shown in FIG. 4, the second light transmitting region 102 may be at least one horizontal bar pattern, at least one straight bar pattern and/or at least one corner pattern located beyond the touch region 104.

When the second light source 146 is turned on and the touch module 142 senses that the first light transmitting region 100 is no longer touched, the controller 140 turns off the second light source 146. For further explanation, when the user removes the finger 3 from the first light transmitting region 100 (i.e. the finger 3 no longer touches the first light transmitting region 100), the controller 140 will turn off the second light source 146, such that the light emitted from the second light transmitting region 102 disappears, as shown in FIG. 1. Accordingly, only when the touch module 142 senses that the first light transmitting region 100 is touched, the second light transmitting region 102 will emit light to prompt the user whether the touch action has been performed.

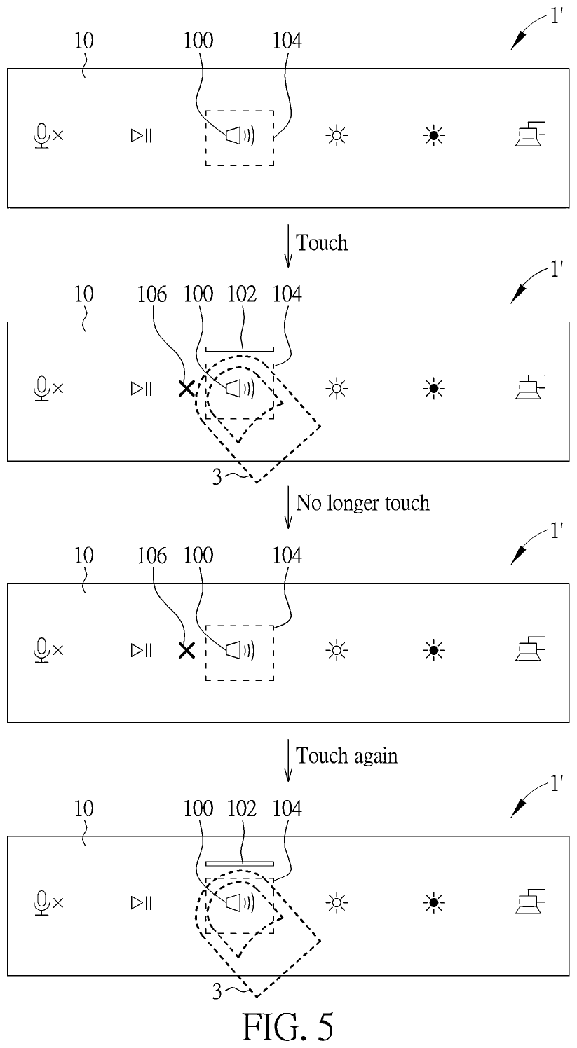

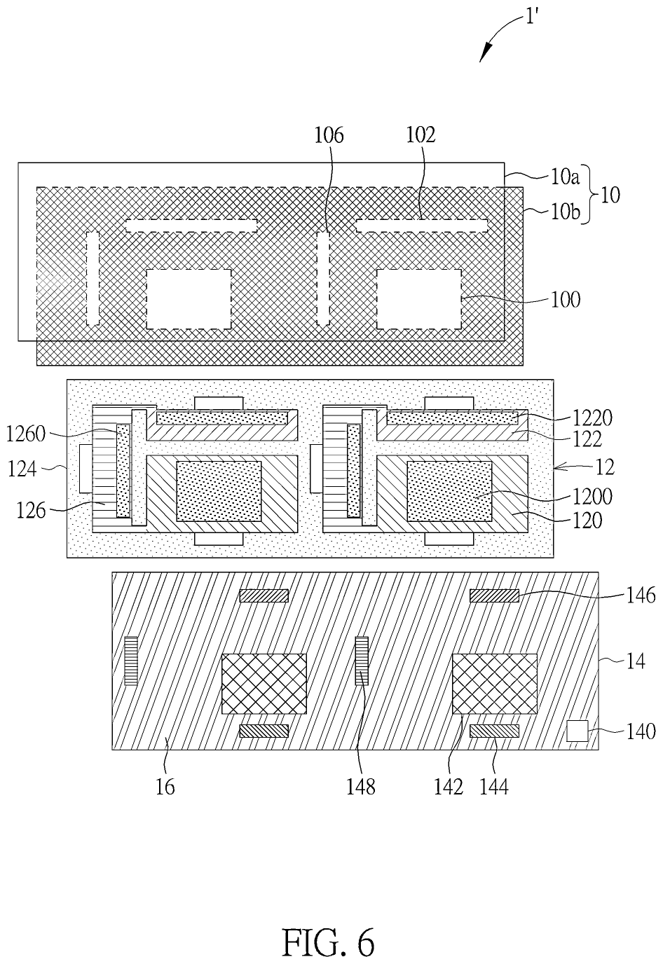

Referring to FIGS. 5 and 6, FIG. 5 is a schematic view illustrating a touch operation of an illuminated touchpad 1′ according to another embodiment of the invention, and FIG. 6 is a partial exploded view illustrating the illuminated touchpad 1′ shown in FIG. 5.

The main difference between the illuminated touchpad 1′ and the aforesaid illuminated touchpad 1 is that the panel 10 of the illuminated touchpad 1′ further comprises a third light transmitting region 106, the light guide layer 12 of the illuminated touchpad 1′ further comprises a third light guide region 126, and the circuit board 14 of the illuminated touchpad 1′ further comprises a third light source 148, wherein the third light guide region 126 overlaps with the third light transmitting region 106, and the third light source 148 is located at a side of the third light guide region 126, as shown in FIGS. 5 and 6. The third light transmitting region 106 may be formed on the aforesaid light shielding layer 10b, and the third light source 148 may be a light emitting diode (LED) or other components capable of emitting light. It should be noted that the same elements in FIGS. 5-6 and FIGS. 1-3 are represented by the same numerals, so the repeated explanation will not be depicted herein again.

In this embodiment, the second light transmitting region 102 and the third light transmitting region 106 may be located at two adjacent sides of the first light transmitting region 100, but the invention is not so limited. In this embodiment, the first light guide region 120, the second light guide region 122 and the third light guide region 126 are located on an identical plane. For example, the first light guide region 120, the second light guide region 122 and the third light guide region 126 may be three light guide plates spaced side by side. The three light guide plates may be connected or not according to practical applications. As shown in FIG. 6, the third light guide region 126 may connect the first light guide region 100 and the second light guide region 102, but the invention is not so limited. Furthermore, the aforesaid light shielding structure 124 separates the first light guide region 120, the second light guide region 122 and the third light guide region 126, so as to prevent the light within the first light guide region 120, the second light guide region 122 and the third light guide region 126 from interfering with each other. In this embodiment, the third light guide region 126 may have a third micro-structure 1260, wherein the third micro-structure 1260 overlaps with the third light transmitting region 106 and does not overlap with the touch module 142. The third micro-structure 1260 is configured to reflect light toward the third light transmitting region 106.

When the illuminated touchpad 1 is powered on, the controller 140 controls the first light source 144 to emit light, such that the first light guide region 120 guides the light emitted by the first light source 144 to the first light transmitting region 100 to emit light, so as to form an illuminated pattern (e.g. touch icon) corresponding to the first light transmitting region 100. Accordingly, a user can accurately find the desired touch position according to the illuminated pattern. In this embodiment, when the first light transmitting region 100 is not touched, the second light source 146 and the third light source 148 do not emit light. In other words, when the user does not touch the first light transmitting region 100, only the first light transmitting region 100 will emit light, and the second light transmitting region 102 and the third light transmitting region 106 will not emit light.

When the user wants to perform a touch function corresponding to the first light transmitting region 100, the user may use a finger 3 to touch the first light transmitting region 100, as shown in FIG. 5. When the touch module 142 senses that the first light transmitting region 100 is touched, the controller 140 controls the second light source 146 and the third light source 148 to emit light according to the sensing signals output by the touch module 142. At this time, the second light guide region 122 guides the light emitted by the second light source 146 to the second light transmitting region 102 to emit light, so as to form an illuminated effect corresponding to the second light transmitting region 102 as a prompt for a touch action. The user may confirm whether the touch action has been performed through the prompt of the touch action. At the same time, the third light guide region 126 guides the light emitted by the third light source 148 to the third light transmitting region 106 to emit light, so as to form an illuminated pattern (e.g. an icon corresponding to the touch function of the first light transmitting region 100) corresponding to the third light transmitting region 106.

When the second light source 146 is turned on and the touch module 142 senses that the first light transmitting region 100 is no longer touched, the controller 140 turns off the second light source 146. For further explanation, when the user removes the finger 3 from the first light transmitting region 100 (i.e. the finger 3 no longer touches the first light transmitting region 100), the controller 140 will turn off the second light source 146, such that the light emitted from the second light transmitting region 102 disappears, as shown in FIG. 5. Accordingly, only when the touch module 142 senses that the first light transmitting region 100 is touched, the second light transmitting region 102 will emit light to prompt the user whether the touch action has been performed. Furthermore, when the third light source 148 is turned on and the touch module 142 senses that the first light transmitting region is no longer touched, the controller 140 does not turn off the third light source 148, such that the third light transmitting region 106 keeps emitting light. Accordingly, the user may know the status of the touch function corresponding to the first light transmitting region 100 according to the illuminated pattern of the third light transmitting region 106. For example, the touch function corresponding to the first light transmitting region 100 may be speaker volume adjustment, and the illuminated pattern of the third light transmitting region 106 may be a mute icon. When the third light transmitting region 106 emits light, it means that the speaker is in a mute state.

When the third light source 148 is turned on and the touch module 142 senses that the first light transmitting region 100 is touched again, the controller 140 turns off the third light source 148. For further explanation, when the third light source 148 is turned on and the user uses the finger 3 to touch the first light transmitting region 100 again, the controller 140 will turn off the third light source 148, such that the light emitted from the third light transmitting region 106 disappears, as shown in FIG. 5. For example, when the third light transmitting region 106 does not emit light, it means that the speaker is in a non-mute state.

As mentioned in the above, the invention disposes the first light guide region and the second light guide region in the same light guide layer. The light emitted by the first light source is guided to the first light transmitting region of the panel through the first light guide region to emit light, so as to form an illuminated pattern (e.g. touch icon) corresponding to the first light transmitting region. Furthermore, when the touch module senses that the first light transmitting region is touched, the controller controls the second light source to emit light. At this time, the light emitted by the second light source is guided to the second light transmitting region of the panel through the second light guide region to emit light, so as to form an illuminated effect corresponding to the second light transmitting region as a prompt for a touch action. A user may confirm whether the touch action has been performed through the prompt of the touch action. Since the first light guide region and the second light guide region are disposed in the same light guide layer (i.e. the first light guide region and the second light guide region are located on an identical plane), the first light guide region and the second light guide region will not increase the overall thickness of the illuminated touchpad, such that it is beneficial to a thin design of the illuminated touchpad. Furthermore, the same light guide layer including multiple light guide regions is also easier to be assembled. Since the first light transmitting region and the second light transmitting region as the illuminated pattern are formed on the panel, the resolution will be better than the pattern formed on a conventional light guide plate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illuminated touchpad comprising:
a panel comprising a first light transmitting region and a second light transmitting region;
a light guide layer located below the panel, the light guide layer comprising a first light guide region and a second light guide region, the first light guide region overlapping with the first light transmitting region, the second light guide region overlapping with the second light transmitting region; and
a circuit board located below the light guide layer, the circuit board comprising a controller, a touch module, a first light source and a second light source, the touch module overlapping with the first light transmitting region, the first light source being located at a side of the first light guide region, the second light source being located at a side of the second light guide region;
wherein the controller controls the first light source to emit light, such that the first light guide region guides the light emitted by the first light source to the first light transmitting region;
wherein, when the touch module senses that the first light transmitting region is touched, the controller controls the second light source to emit light, such that the second light guide region guides the light emitted by the second light source to the second light transmitting region.

2. The illuminated touchpad of claim 1, wherein the first light guide region and the second light guide region are located on an identical plane.

3. The illuminated touchpad of claim 1, wherein the first light guide region and the second light guide region are two light guide plates spaced side by side.

4. The illuminated touchpad of claim 1, wherein the light guide layer further comprises a light shielding structure located between the first light guide region and the second light guide region.

5. The illuminated touchpad of claim 4, wherein the light shielding structure does not overlap with the touch module.

6. The illuminated touchpad of claim 1, wherein, when the second light source is turned on and the touch module senses that the first light transmitting region is no longer touched, the controller turns off the second light source.

7. The illuminated touchpad of claim 1, wherein, when the first light transmitting region is not touched, the second light source does not emit light.

8. The illuminated touchpad of claim 1, wherein the first light guide region has a first micro-structure, the first micro-structure overlaps with the first light transmitting region, the second light guide region has a second micro-structure, and the second micro-structure overlaps with the second light transmitting region.

9. The illuminated touchpad of claim 8, wherein the second micro-structure does not overlap with the touch module.

10. The illuminated touchpad of claim 1, wherein the second light transmitting region does not overlap with the touch module.

11. The illuminated touchpad of claim 1, wherein the panel comprises a light transmitting layer and a light shielding layer, the light shielding layer is disposed at a side of the light transmitting layer, and the light shielding layer is formed with the first light transmitting region and the second light transmitting region.

12. The illuminated touchpad of claim 11, wherein the panel defines a touch region corresponding to the first light transmitting region, and the second light transmitting region is located beyond the touch region.

13. The illuminated touchpad of claim 12, wherein the second light transmitting region is at least one horizontal bar pattern, at least one straight bar pattern and/or at least one corner pattern located beyond the touch region.

14. The illuminated touchpad of claim 1, wherein the panel further comprises a third light transmitting region, the light guide layer further comprises a third light guide region, the third light guide region overlaps with the third light transmitting region, the circuit board further comprises a third light source, and the third light source is located at a side of the third light guide region; wherein, when the touch module senses that the first light transmitting region is touched, the controller controls the third light source to emit light, such that the third light guide region guides the light emitted by the third light source to the third light transmitting region.

15. The illuminated touchpad of claim 14, wherein, when the third light source is turned on and the touch module senses that the first light transmitting region is no longer touched, the controller does not turn off the third light source.

16. The illuminated touchpad of claim 15, wherein, when the third light source is turned on and the touch module senses that the first light transmitting region is touched again, the controller turns off the third light source.

17. The illuminated touchpad of claim 14, wherein the second light transmitting region and the third light transmitting region are located at two adjacent sides of the first light transmitting region.

18. The illuminated touchpad of claim 14, wherein the third light guide region connects the first light guide region and the second light guide region.

19. The illuminated touchpad of claim 14, wherein the light guide layer further comprises a light shielding structure separating the first light guide region, the second light guide region and the third light guide region.

20. The illuminated touchpad of claim 14, wherein the third light guide region has a third micro-structure, and the third micro-structure overlaps with the third light transmitting region and does not overlap with the touch module.
